(19) United States
(12) Patent Application Publication
(10) Pub. No.: US 2012/0070525 A1
(43) Pub. Date: Mar. 22, 2012

(54) MOULD WITH REPLACEABLE MOULD CORE

(75) Inventors: Xian-yun Wang, Tu Cheng (TW); Shih-hsiung Ho, Tu Cheng (TW); Gang-fu Cai, Tu Cheng (TW); Xiao-ping Wu, Tu Cheng (TW)

(73) Assignee: Cheng Uei Precision Industry Co., LTD., Tu Cheng City (TW)

(21) Appl. No.: 12/884,662

(22) Filed: Sep. 17, 2010

(51) Int. Cl. B29C 33/20; B29C 33/44

(52) U.S. Cl. 425/161

(57) ABSTRACT

Provided is a mould with flat thimble including a lower mould, a mould core, a plurality of thimbles, an upper mould and an anti-pulling out mechanism. The anti-pulling out mechanism is mounted on the lower and upper moulds, and includes at least one spring locking steel ball, a lower ejector pin, an upper ejector pin and a movable locking pin. The movable locking pin forms a holding recess. The spring locking steel ball is mounted on one side of a core through hole of the mould core. The upper ejector pin is fixed on the upper mould. The movable locking pin is placed in the lower through hole and the core through hole. The present mould can prevent the operator from pulling out the mould core before the molding product being pushed out, so that avoiding damaging the thimble and reducing production cost of the product.

### BACKGROUND OF THE INVENTION

1. Field of the Invention

The present invention relates to a mould, and more particularly to a mould with replaceable mould core.

2. Description of the Prior Art

Generally, a mould with replaceable mould core employs a thimble for pushing out the molding product after injection molding, thereby removing the molding product from the mould. When the thimble is completely withdrawn from the mould core, the mould core can be drawn out for being replaced.

But for the prior mould with replaceable mould core, the thimble may be broken if the mould core is drawn out before the molding product being pushed out because of incorrect operation of the operator, so that resulting in adding production cost.

### BRIEF SUMMARY OF THE INVENTION

An object of the present invention is to provide a mould with replaceable mould core, which can avoid false operation so that protecting a thimble and reducing production cost of the product.

To achieve the above object, in accordance with the present invention, a mould with replaceable mould core is provided, comprising a lower mould, a mould core, a plurality of thimbles, an upper mould and an anti-pulling out mechanism. The lower mould includes a lower plate, an ejector plate and an auxiliary plate. Wherein the lower plate disposes an inserting recess on one side thereof, the auxiliary plate disposes a lower through hole, which is adjacent to one end of the inserting recess, the lower mould forms a cavity, and the ejector plate is movable mounted in the cavity. The mould core is mounted in the inserting recess of the lower plate and forms a core through hole, which is corresponding to the lower through hole and is communicated with the lower through hole. The thimbles are mounted on the lower mould. The upper mould is cooperated with the lower mould. The anti-pulling out mechanism is mounted on the lower and upper moulds, and includes at least one spring locking steel ball, a lower ejector pin, an upper ejector pin and a movable locking pin. Wherein the movable locking pin forms a holding recess, the spring locking steel ball is mounted on one side of the core through hole, one end of the lower ejector pin is received in the lower through hole and the other end thereof presses against the ejector plate, the upper ejector pin is fixed on the upper mould and is corresponding to the core through hole, the movable locking pin is placed in the lower through hole and the core through hole.

Based on the above description, a mould with replaceable mould core as provided by the present invention can prevent the operator from pulling out the mould core before the molding product being pushed out because of false operation, so that avoiding damaging the thimble and reducing production cost of the product.

### BRIEF DESCRIPTION OF THE DRAWINGS

FIG. 1 is a structure schematic view of a mould with replaceable mould core according to one embodiment of the present invention, which shows a partial inner structure thereof;

FIG. 2 is a structure schematic view of a lower mould of FIG. 1, which shows a partial inner structure thereof;

FIG. 3 is an enlarged view of part I in FIG. 1;

FIG. 4 is a structure schematic view of a lower mould and a upper mould detached from the lower mould, wherein a partial inner structure is shown; and

FIG. 5 is an enlarged view of part II of FIG. 4.

### DETAILED DESCRIPTION OF THE PREFERRED EMBODIMENTS

The following embodiment with reference to the accompanying drawings now has been given for detail describing the technology, the feature, the object and the effect of the present invention.

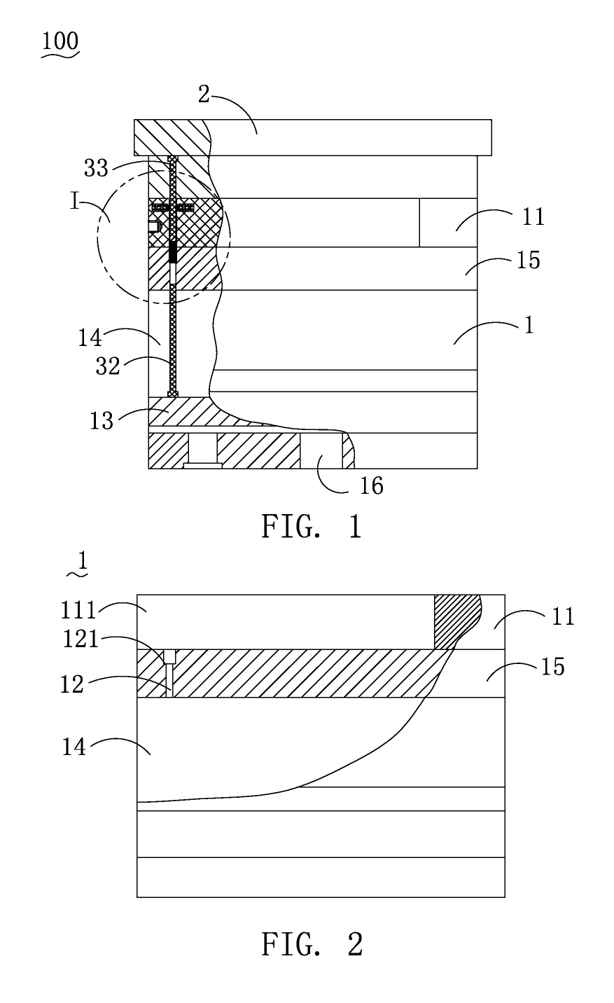

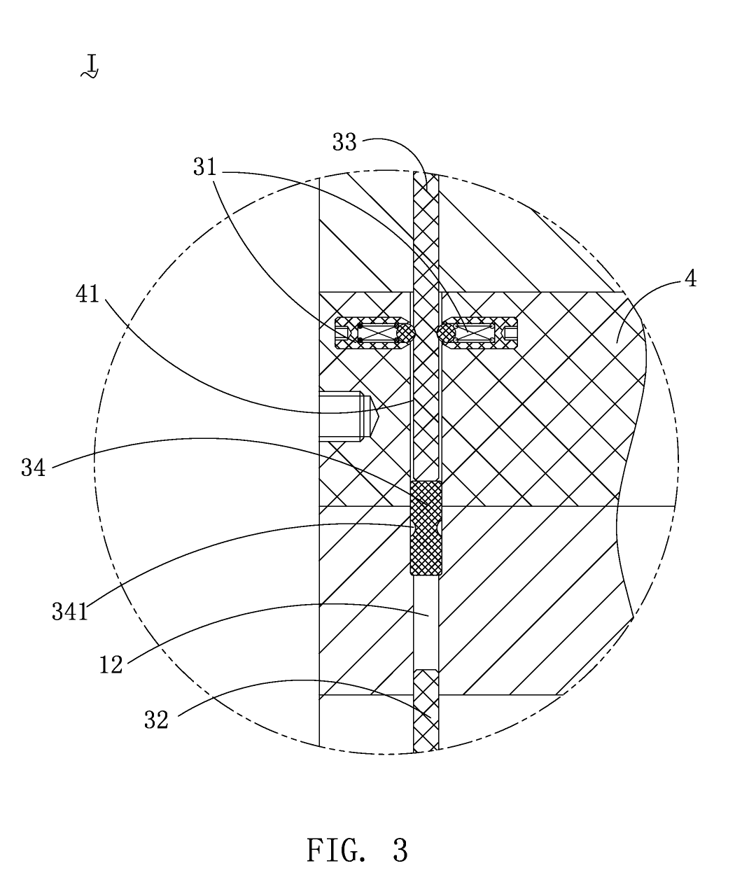

Please refer to FIGS. 1 and 3, a mould 100 with replaceable mould core of the present invention comprises a lower mould 1, a upper mould 2 cooperating with the lower mould 1, a mould core 4, a plurality of thimbles (not shown in all FIGS) and an anti-pulling out mechanism.

Please refer to FIGS. 1 and 2, the lower mould 1 includes a lower plate 11, an ejector plate 13 and an auxiliary plate 15. The lower plate 11 forms an inserting recess 111 on one side thereof. The auxiliary plate 15 forms a lower through hole 12, which is adjacent to one end of the inserting recess 111. The lower through hole 12 has a blocking recess 121 on an upper end thereof. The lower mould 1 forms a cavity 14. The ejector plate 13 is movable mounted in the cavity 14. The lower mould 1 forms an opening 16 communicated with the cavity 14 on a bottom surface thereof.

Referring to FIGS. 1 to 3, the mould core 4 is mounted on the inserting recess 111 of the lower plate 11. The mould core 4 forms a core through hole 41 corresponding to the lower through hole 12 and being communicated with the lower through hole 12.

Referring to FIGS. 1 to 3, the anti-pulling out mechanism is used to prevent the operator from pulling out the mould core 4 before the molding product is pushed out. Specifically, the anti-pulling out mechanism is mounted on the lower mould 1 and the upper mould 2, and includes two spring locking steel balls 31, a lower ejector pin 32, an upper ejector pin 33 and a movable locking pin 34. The movable locking pin 34 forms a holding recess 341. The two spring locking steel balls 31 are separately mounted on two sides of the core through hole 41. One end of the lower ejector pin 32 is received in the lower through hole 12, and the other end thereof presses against the ejector plate 13. The upper ejector pin 33 is fixed on the upper mould 2 and is corresponding to the core through hole 41. The movable locking pin 34 is placed in the lower through hole 12 and the core through hole 41.

The pluralities of thimbles (not shown in all FIGS) are mounted on the lower mould 1 for pushing out the molding product from the mould core 4.

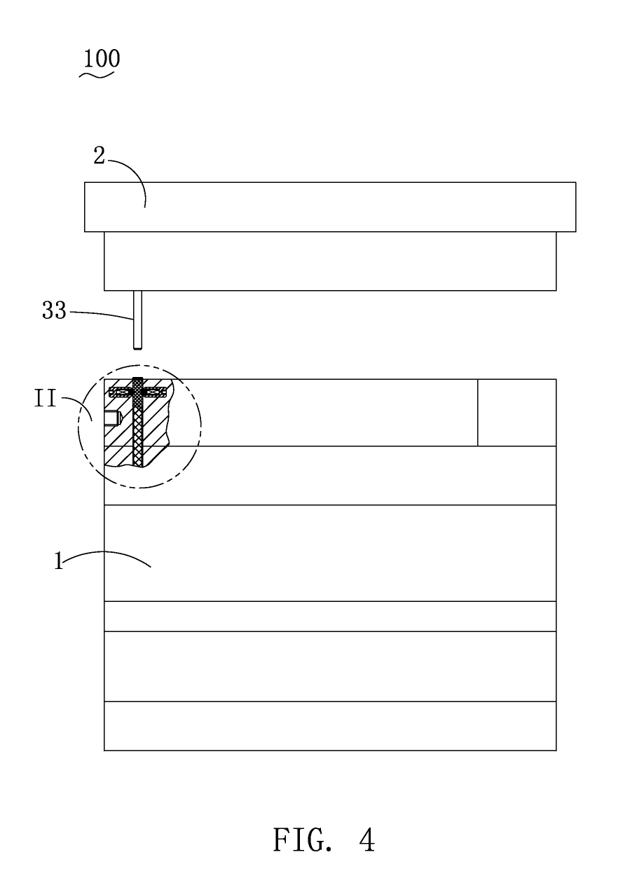

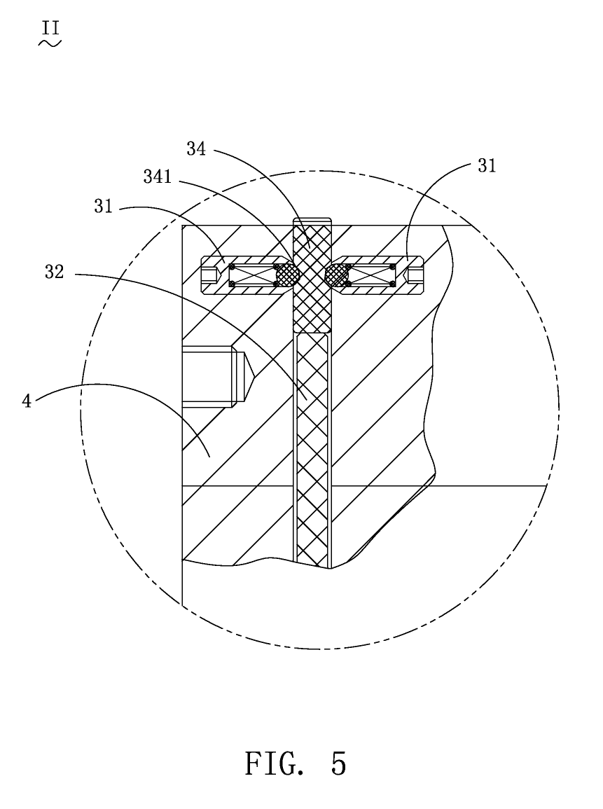

Referring to FIGS. 1 to 5, when needing to replace the mould core 4, it is needed to separate the upper mould 2 from the lower mould 1, as shown in FIG. 4. Specifically, the ejector plate 13 is pushed upward by applying force through the opening 16, the ejector plate 13 drives the lower ejector pin 32 to push the movable locking pin 34 to move upward until the two spring locking steel balls 31 is engaged with the holding recess 341 of the movable locking pin 34, and then the ejector plate 13 returns to the original location. Now, the movable locking pin 34 is separated from the lower mould 1 can be drawn out for being replaced. When closing the mould 100, the upper ejector pin 33 of the upper mould 2 can push the movable locking pin 34 downward until a lower end of the movable locking pin 34 arrives at and presses against the blocking recess 121 of the lower through hole 12. Now, the movable locking pin 34 is located between the lower through hole 12 and a core through hole 41, so that the mould core 4 cannot be taken out.

As described above, the mould 100 of the present invention employs the movable locking pin 34, which can be located between the lower through hole 12 and a core through hole 41 during the course of closing the mould, to prevent the operator from pulling out the mould core 4 before the molding product being pushed out because of false operation, so that avoiding damaging the thimble and reducing production cost of the product.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mould with replaceable mould core comprising:
a lower mould, including a lower plate, an ejector plate and an auxiliary plate, wherein the lower plate disposes an inserting recess on one side thereof, the auxiliary plate disposes a lower through hole, which is adjacent to one end of the inserting recess, the lower mould forms a cavity, and the ejector plate is movable mounted in the cavity;
a mould core, being mounted in the inserting recess of the lower plate, and forming a core through hole, which is corresponding to the lower through hole and is communicated with the lower through hole;
a plurality of thimbles, being mounted on the lower mould;
an upper mould, being cooperated with the lower mould; and
an anti-pulling out mechanism, being mounted on the lower and upper moulds, and including at least one spring locking steel ball, a lower ejector pin, an upper ejector pin and a movable locking pin, wherein the movable locking pin forms a holding recess, the spring locking steel ball is mounted on one side of the core through hole, one end of the lower ejector pin is received in the lower through hole and the other end thereof presses against the ejector plate, the upper ejector pin is fixed on the upper mould and is corresponding to the core through hole, and the movable locking pin is placed in the lower through hole and the core through hole.

2. The mould with replaceable mould core as claimed in claim 1, wherein the lower through hole has a blocking recess on an upper end thereof, and the lower mould forms an opening communicated with the cavity on a bottom surface thereof.
